(19) United States
(12) Patent Application Publication
(10) Pub. No.: US 2008/0220289 A1
(43) Pub. Date: Sep. 11, 2008

(54) ORGANIC LIGHT EMITTING DEVICE AND INK COMPOSITION EACH USING OLIGOFLUORENE COMPOUND AND DISPLAY APPARATUS

(75) Inventors: Shunsuke Shioya, Abiko-shi (JP); Koichi Suzuki, Yokohama-shi (JP); Satoru Shiobara, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/036,427

(22) Filed: Feb. 25, 2008

(30) Foreign Application Priority Data
Mar. 8, 2007 (JP) 2007-058181

(51) Int. Cl. B32B 9/04; C09D 11/00

(52) U.S. Cl. 428/691; 106/31.13

(57) ABSTRACT

There is provided an organic light emitting device including: an anode, a cathode, and layer containing an organic compound, the layer being interposed between the anode and the cathode, in which the layer containing an organic compound contains at least one kind of the oligofluorene compound represented by the following general formula (I):

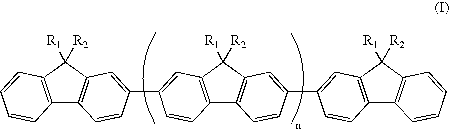

wherein: R₁ and R₂ each represent an alkyl group, and may be identical to or different from each other, and R₁'s and R₂'s by which different fluorene rings are substituted may be identical to or different from each other, provided that at least four substituents of all substituents each represented by R₁ or R₂ are each an alkyl group having 4 or more carbon atoms, and at least four substituents of all the substituents are each an alkyl group having 1 or 2 carbon atoms; and n represents an integer of 4 to 10.

### BACKGROUND OF THE INVENTION

1. Field of the Invention

The present invention relates to an organic light emitting device and an ink composition each using an oligofluorene compound, and a display apparatus.

2. Description of the Related Art

Since electric field light emitting devices are each of a selfluminous type, each of the devices has high visibility, is excellent in display performance, and can respond to the user's operation at a high speed. In addition, each of the electric field light emitting devices can be reduced in thickness, so each of the devices has been attracting attention because of its potential to serve as a display device such as a flat display.

Of the devices, an organic light emitting device using an organic compound as a light emitter has, for example, the following characteristics: the organic light emitting device can be driven at a lower voltage than the voltage at which an inorganic light emitting device is driven, can be increased in area easily as compared to the inorganic light emitting device, and can easily obtain a desired luminescent color by selecting an appropriate dyestuff as compared to the inorganic light emitting device. Accordingly, the organic light emitting device has been vigorously developed because of its potential to serve as a next-generation display.

Here, methods of producing organic light emitting devices each using an organic compound as a light emitter are roughly classified into the following two types: one type is such that a device is produced by forming a low-molecular-weight compound into a film by a dry process such as a vacuum vapor deposition method, and the other type is such that the device is produced by forming the low-molecular-weight compound into a film by the so-called application film formation method such as a spin coating method, a casting method, or an inkjet method.

An organic light emitting device produced by the above application film formation method (hereinafter referred to as “application type organic light emitting device”) has, for example, the following merits as compared to an organic light emitting device produced by the dry process:
(1) the device can be produced at a low cost;
(2) the device can be increased in area easily; and
(3) the amount of a dopant or the like to be introduced into the device can be precisely controlled at the time of the introduction.

The above application type organic light emitting device will be described with reference to figures. FIG. 4 is a sectional view illustrating the general constitution of the application type organic light emitting device. An organic light emitting device 110 shown in FIG. 4 is obtained by sequentially laminating an anode 101, a hole injecting layer 102, a light emitting layer 103, an electron injecting layer 104, and a cathode 105 on a substrate 100.

In the organic light emitting device 110, a mixture of polyethylenedioxythiophene and polystyrene sulfonic acid (PEDOT:PSS) is generally used in the hole injecting layer 102, and the layer is formed by an application film formation method such as spin coating. The mixture PEDOT:PSS is soluble in water, but is insoluble in a non-polar solvent. Accordingly, even when the light emitting layer 103 is formed by an application film formation method involving the use of a non-polar solvent, the PEDOT:PSS film as the hole injecting layer 102 is not eluted. Therefore, the mixture is regarded as a suitable hole injecting material upon production of an organic light emitting device by an application film formation method.

A polymer compound having light emission property is mainly used upon production of the light emitting layer 103 by an application film formation method. This is because the polymer compound hardly crystallizes as compared to a low-molecular-weight-based compound by virtue of its high non-liquid crystallinity. A material to be used is specifically a polymer compound such as polyphenylene vinylene (PPV), polyfluorene (PF), polyvinyl carbazole (PVK), or a derivative of each of them. In addition, specific examples of the application film formation method upon production of the light emitting layer 103 include a spin coating method and an inkjet method.

After the formation of the light emitting layer 103, the electron injecting layer 104 formed of lithium fluoride or the like, and the cathode 105 formed of a metal electrode are sequentially formed on the light emitting layer 103 by employing a vacuum vapor deposition method, whereby the organic light emitting device 110 is completed.

As described above, the application type organic light emitting device has the excellent characteristic, i.e., the device can be produced by a simple process. Accordingly, the device is expected to find use in a variety of applications. However, the device involves the following problems to be solved: the device cannot provide sufficiently large emission intensity, and does not have a sufficient lifetime.

Various proposals have been made in relation to a cause for the fact that the device cannot provide sufficiently large emission intensity; one cause for the fact is considered to consist in difficulty in controlling the molecular weight of the polymer compound or in purifying the compound.

One possible approach to solving the above problem involves the use of an oligomer compound having the following characteristics: the molecular weight of the compound can be easily controlled, the compound can be easily purified, and the compound has high non-liquid crystallinity.

The case where an oligomer material is applied to an organic light emitting material is described in, for example, each of Japanese Patent Application Laid-Open No. 2003-55275 and S. W. Culligan et al., Advanced Material, 2003, 15, No. 14, p 1176.

However, an oligofluorene compound represented by the following formula used in S. W. Culligan et al., Advanced Material, 2003, 15, No. 14, p 1176 has liquid crystallinity, and its phase transition temperature is around 120° C. Accordingly, upon driving of an organic light emitting device using the compound, the temperature of the device itself may increase to such an extent that the temperature exceeds the phase transition temperature at which the compound undergoes a phase transition to a liquid crystal phase, with the result that the above oligofluorene compound is turned into liquid crystal. In addition, once the compound is turned into liquid crystal, the quality of a film formed of the compound largely changes, with the result that the characteristics of the device also largely change. Accordingly, the following problem arises: only a device poor in stability can be provided.

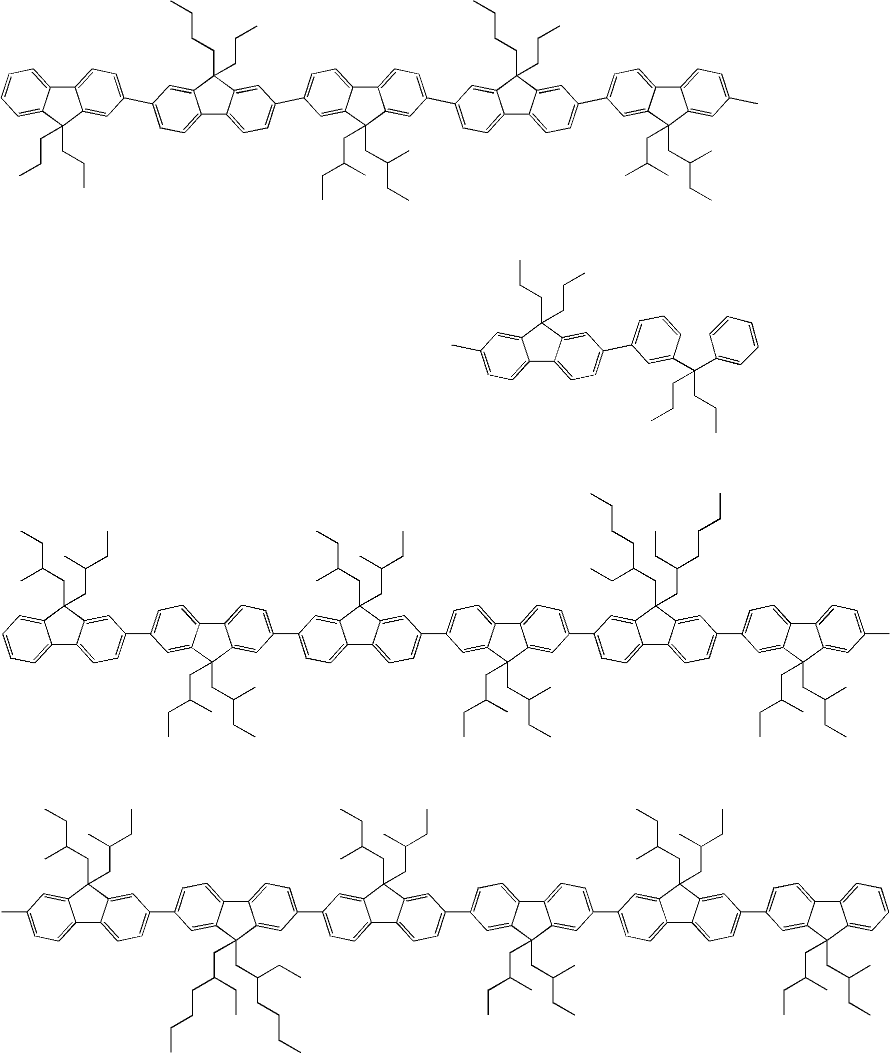

The above oligofluorene compound has liquid crystallinity probably because all fluorene units each have a long-chain alkyl group.

In view of the foregoing, the following contrivance has been proposed to make the compound non-liquid crystallinity: each of the alkyl groups is shortened. However, the shortening of each of the alkyl groups makes it difficult to improve the solubility of the compound in an organic solvent such as a non-polar solvent, and makes it difficult to form a film from the compound by application.

In addition, in S. W. Culligan et al., Advanced Material, 2003, 15, No. 14, p 1176, a light emitting layer is formed only of the oligofluorene compound. Accordingly, an organic light emitting device described in the document can emit only blue monochromatic light, and its efficiency is not improved unlike a host/guest-based organic light emitting device. In addition, the above oligofluorene compound is provided with a large number of long-chain alkyl groups, so a concern is raised about an increase in resistance of the device.

In Japanese Patent Application Laid-Open No. 2003-55275 as well, an organic light emitting device is produced by using an oligofluorene compound, and the compound shows superiority over polyfluorene. However, in Japanese Patent Application Laid-Open No. 2003-55275, the structure of the oligofluorene compound itself to be used in an application type organic light emitting device is not optimized. Accordingly, the optimization of the structure of the oligofluorene compound is expected to improve the light emitting efficiency and durability of the organic light emitting device additionally.

### SUMMARY OF THE INVENTION

The present invention has been made in view of the above problems. An object of the present invention is to provide an organic light emitting device which: uses an oligofluorene compound; and is excellent in light emitting efficiency and durability. Another object of the present invention is to provide an ink composition suitable for the formation of a layer of which the organic light emitting device is formed. Another object of the present invention is to provide a display apparatus including the above organic light emitting device.

The present invention provides an organic light emitting device including an anode, a cathode, and a layer containing an organic compound, the layer being interposed between the anode and the cathode, in which the layer containing an organic compound contains at least one kind of an oligofluorene compound represented by the following general formula (I):

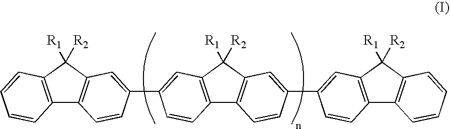

wherein:

R₁ and R₂ each represent an alkyl group, and may be identical to or different from each other, and R₁'s and R₂'s by which different fluorene rings are substituted may be identical to or different from each other, provided that at least four substituents of all substituents each represented by R₁ or R₂ are each an alkyl group having 4 or more carbon atoms, and at least four substituents of all the substituents are each an alkyl group having 1 or 2 carbon atoms. n represents an integer of 4 to 10.

According to the present invention, there can be provided an organic light emitting device which: uses an oligofluorene compound; and is excellent in light emitting efficiency and durability. In addition, according to the present invention, there can be provided an ink composition suitable for the formation of a layer of which the organic light emitting device is formed. Further, according to the present invention, there can be provided a display apparatus including the above organic light emitting device.

Further features of the present invention will become apparent from the following description of exemplary embodiments with reference to the attached drawings.

### BRIEF DESCRIPTION OF THE DRAWINGS

FIG. 1 is a sectional view illustrating a first embodiment in an organic light emitting device of the present invention.

FIG. 2 is a sectional view illustrating a second embodiment in the organic light emitting device of the present invention.

FIG. 3 is a sectional view illustrating a third embodiment in the organic light emitting device of the present invention.

FIG. 4 is a sectional view illustrating the general constitution of an application type organic light emitting device.

### DESCRIPTION OF THE EMBODIMENTS

Hereinafter, the present invention will be described in detail. However, the present invention is not limited by the following description.

An organic light emitting device of the present invention is formed of: an anode; a cathode; and a layer containing an organic compound, the layer being interposed between the anode and the cathode.

Hereinafter, the organic light emitting device of the present invention will be described in detail with reference to the figures.

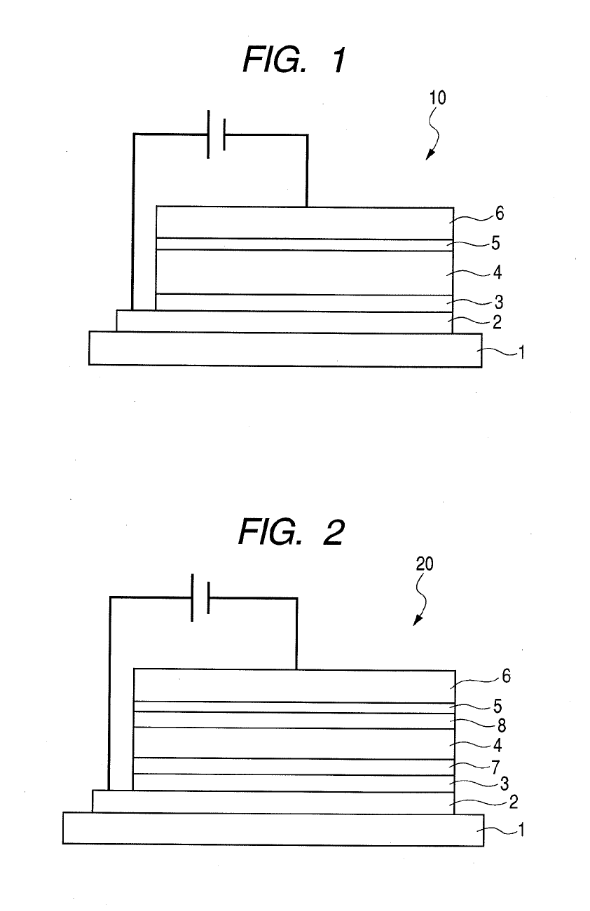

First, reference numerals shown in FIGS. 1 to 4 including the above-mentioned reference numerals shown in FIG. 4 will be described.

Reference numeral 1 represents a substrate; 2, an anode; 3, a hole injecting layer; 4, a light emitting layer; 5, an electron injecting layer; 6, a cathode; 7, a hole transporting layer; 8, an electron transporting layer; and 9, an electron blocking layer.

In addition, reference numerals 10, 20, and 30 each represent an organic light emitting device.

In addition, reference numeral 100 represents the substrate; 101, the anode; 102, the hole injecting layer; 103, the light emitting layer; 104, the electron injecting layer; 105, the cathode; and 110, the organic light emitting device.

FIG. 1 is a sectional view illustrating a first embodiment in the organic light emitting device of the present invention.

The organic light emitting device 10 shown in FIG. 1 is obtained by sequentially laminating the anode 2, the hole injecting layer 3, the light emitting layer 4, the electron injecting layer 5, and the cathode 6 on the substrate 1.

FIG. 2 is a sectional view illustrating a second embodiment in the organic light emitting device of the present invention.

The organic light emitting device 20 shown in FIG. 2 is different from the organic light emitting device 10 shown in FIG. 1 in that: the hole transporting layer 7 is provided between the hole injecting layer 3 and the light emitting layer 4; and the electron transporting layer 8 is provided between the light emitting layer 4 and the electron injecting layer 5. The property with which a carrier is injected into the light emitting layer 4 is improved by providing the hole transporting layer 7 and the electron transporting layer 8. In addition, the organic light emitting device of the present invention may have only one of the hole transporting layer 7 and the electron transporting layer 8.

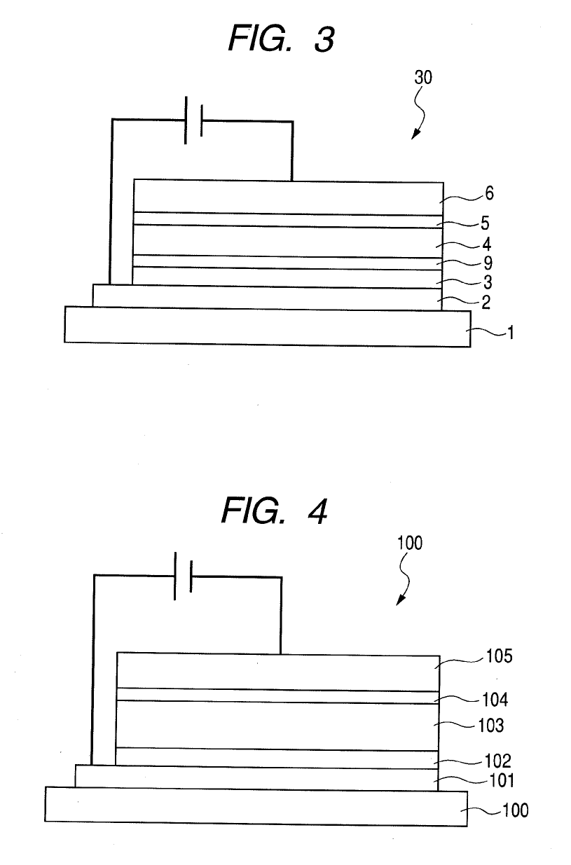

FIG. 3 is a sectional view illustrating a third embodiment in the organic light emitting device of the present invention.

The organic light emitting device 30 shown in FIG. 3 is different from the organic light emitting device 10 shown in FIG. 1 in that the electron blocking layer 9 is provided between the hole injecting layer 3 and the light emitting layer 4. The escape of an electron or an exciton from the light emitting layer 4 to the side of the anode 2 is suppressed by providing the electron blocking layer 9. As a result, the light emitting efficiency of the organic light emitting device is improved.

In addition, the constitution of the organic light emitting device of the present invention is not limited to those described above, and may be, for example, such a constitution that a hole blocking layer is provided between the light emitting layer 4 and the electron injecting layer 5, or such a constitution that both the electron blocking layer and the hole blocking layer are provided.

Alternatively, the constitution of the organic light emitting device of the present invention may be such that only the light emitting layer 4 mediates between the anode 2 and the cathode 6.

The organic light emitting device of the present invention contains, in the layer containing an organic compound, at least one kind of an oligofluorene compound represented by the following general formula (I).

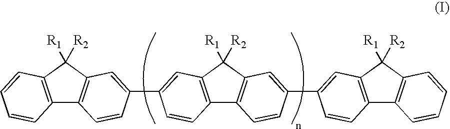

In the formula (I), R₁ and R₂ each represent an alkyl group, and may be identical to or different from each other, and R₁'s and R₂'s by which different fluorene rings are substituted may be identical to or different from each other; provided that at least four substituents of all substituents each represented by R₁ or R₂ are each an alkyl group having 4 or more carbon atoms (preferably an alkyl group having 4 or more to 10 or less carbon atoms), and at least four substituents of all the substituents are each an alkyl group having 1 or 2 carbon atoms.

Examples of the alkyl group having 4 or more carbon atoms represented by each of R₁ and R₂ include, but not particularly limited to, linear, branched, and cyclic alkyl groups. Specific examples of such groups include an n-butyl group, a t-butyl group, a 3-methylbutyl group, a 2-ethylhexyl group, and an octyl group.

The alkyl group having 1 or 2 carbon atoms represented by each of R₁ and R₂ is a methyl group or an ethyl group.

In the formula (I), n represents an integer of 4 to 10.

The oligofluorene compound which: is represented by the general formula (I); and has a long-chain alkyl group having 4 or more carbon atoms and a short-chain alkyl group having 1 or 2 carbon atoms is used as a component for the organic light emitting device of the present invention. The oligofluorene compound brings together high solubility in an organic solvent originating from the long-chain alkyl group and high non-liquid crystallinity as a result of the mixing of the long- and short-chain alkyl groups. Accordingly, the compound can simultaneously solve the crystallization and poor solubility of the compound caused by a reduction in number of the molecules of the compound, and, furthermore, difficulty in controlling the molecular weight of the compound and in purifying the compound caused by an increase in number of the molecules of the compound. In addition, the compound has a reduced number of long-chain alkyl groups, so the resistance of the device can also be reduced.

In addition, the above oligofluorene compound is preferably non-liquid crystallinity. The above oligofluorene compound is preferably non-liquid crystallinity because the fluorene rings of the compound are substituted by an appropriate number of long- and short-chain alkyl groups. Since the compound has such structure, the compound is hardly turned into liquid crystal as compared to the case where each of R₁ and R₂ represents a long-chain alkyl group.

In the case where the compound has liquid crystallinity, when the temperature of the device exceeds the phase transition temperature of the compound, the characteristics of the device change owing to a change in quality of a film formed of the compound in association with the fact that the compound is turned into liquid crystal, with the result that it becomes difficult for the device to emit light stably. Here, when the oligofluorene compound to be used in the organic light emitting device of the present invention is non-liquid crystallinity, the change in quality of the film in association with the fact that the compound is turned into liquid crystal can be solved. As a result, the organic light emitting device can stably emit light.

Hereinafter, representative examples of the oligofluorene compound to be used in the organic light emitting device of the present invention are shown below. However, the present invention is not limited to the examples.

### COMPOUND EXAMPLES

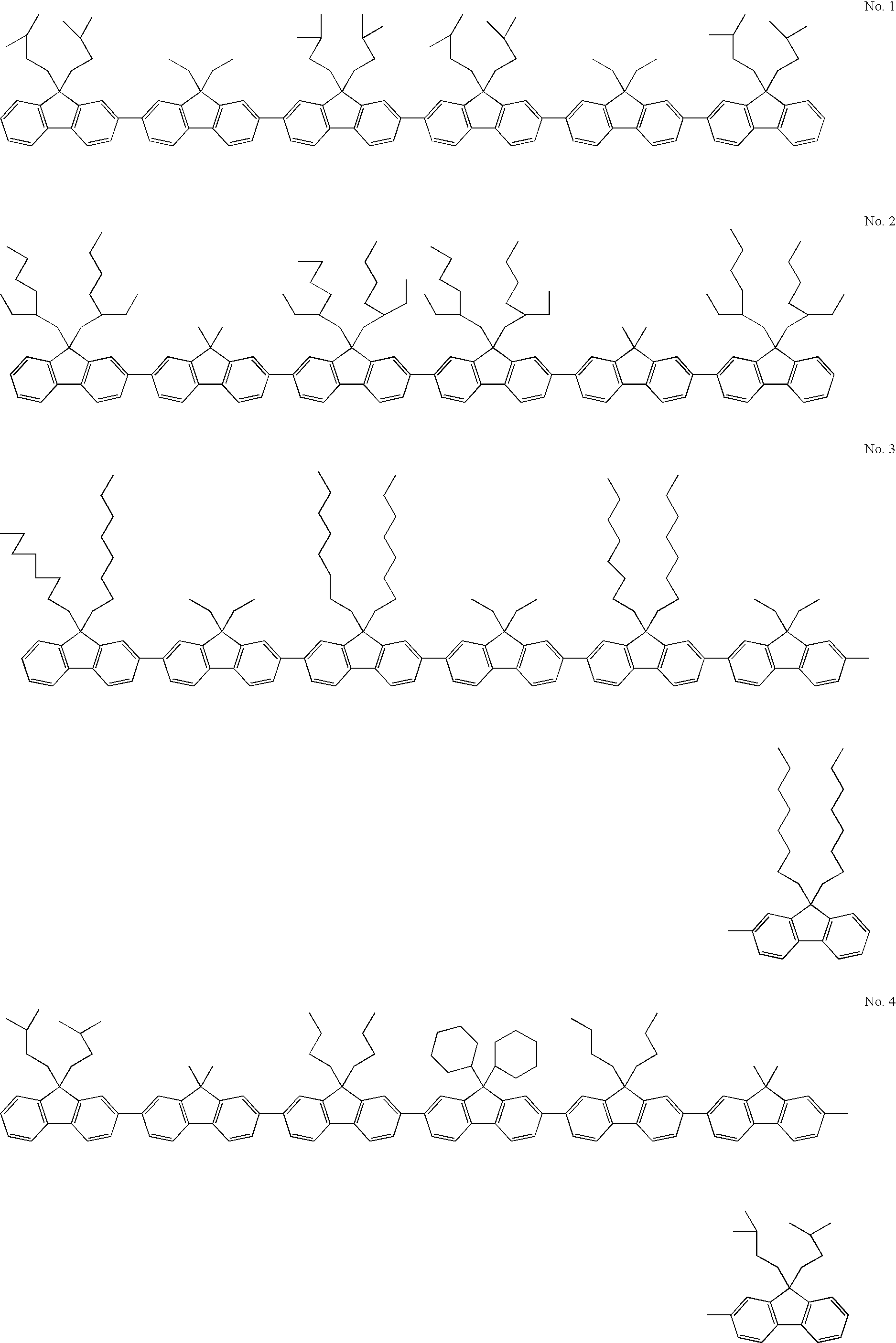

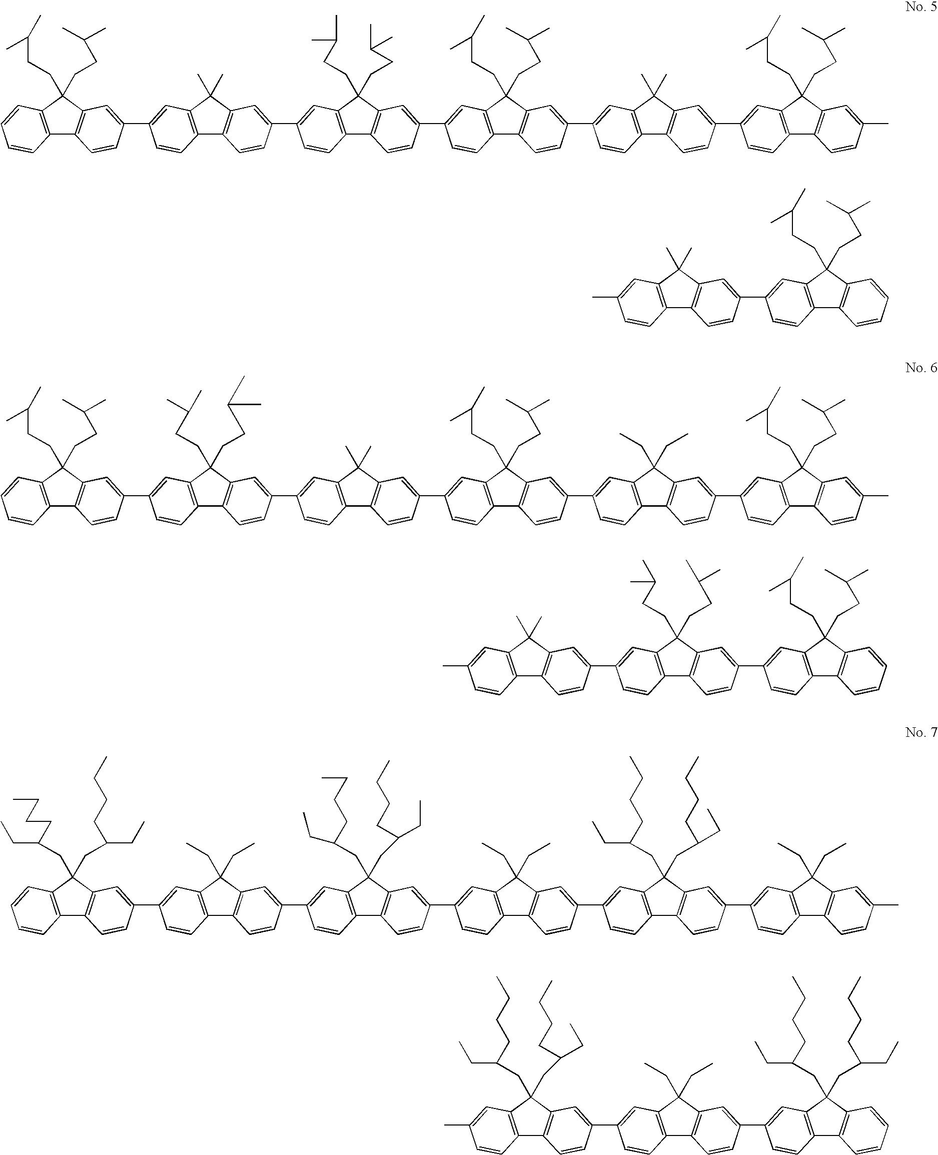

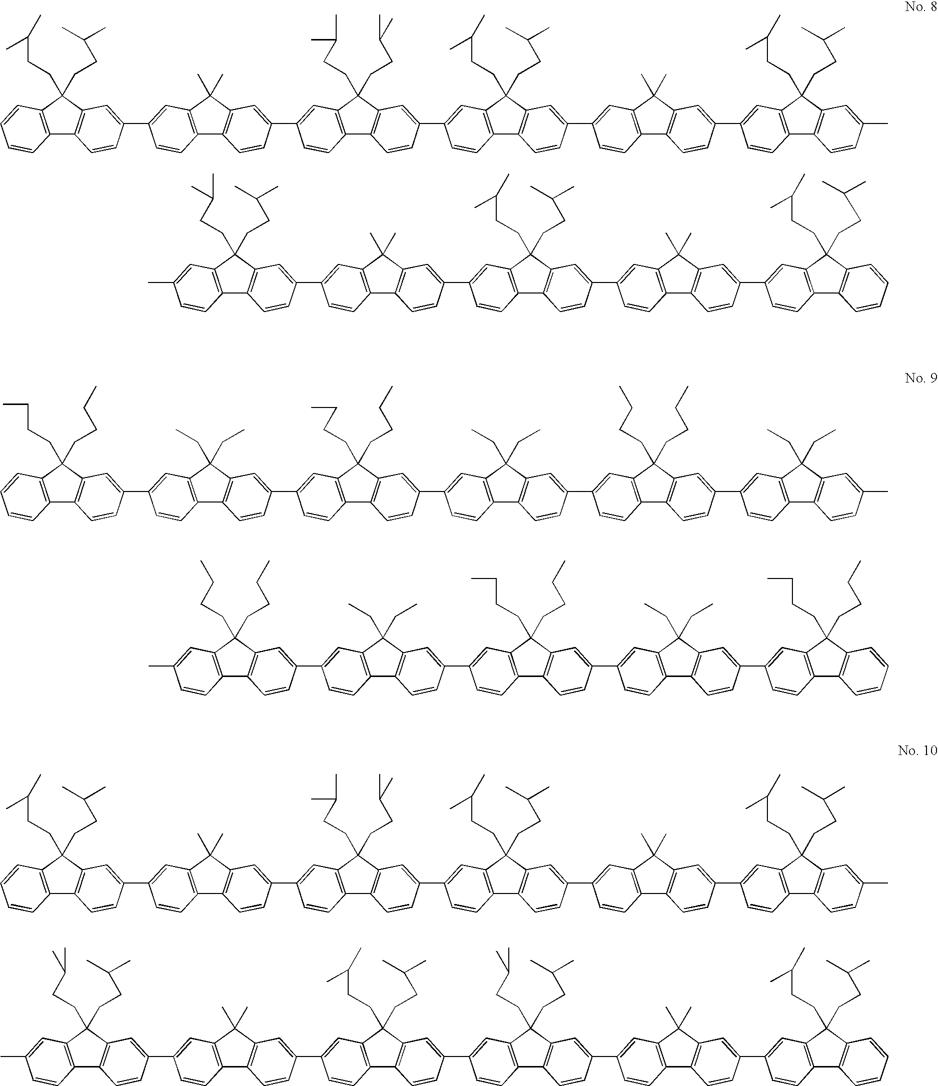

Examples of the layer containing an organic compound, the layer containing the oligofluorene compound represented by the general formula (I), include the hole injecting layer 3, the light emitting layer 4, the electron injecting layer 5, the hole transporting layer 7, the electron transporting layer 8, and the electron blocking layer 9 shown in FIGS. 1 to 3. The oligofluorene compound represented by the general formula (I) may be incorporated into only one of those layers, or may be incorporated into each of two or more of the layers.

In the organic light emitting device of the present invention, the oligofluorene compound represented by the general formula (I) is preferably incorporated into the light emitting layer 4. Here, the light emitting layer 4, which may be formed of the oligofluorene compound alone, is preferably formed of a host and a guest. Here, the oligofluorene compound represented by the general formula (I) is preferably used as the host because its band gap is as wide as about 2.5 to 3.0 eV.

In this case, the guest has only to be a light emitting material, and each of a singlet light emitting material and a triplet light emitting material can be used; the triplet light emitting material is preferably used because the incorporation of the triplet light emitting material as a guest into the light emitting layer 4 additionally improves the light emitting efficiency of the organic light emitting device as light emitted from a triplet can be extracted.

Here, examples of the triplet light emitting material include the following compounds. However, the present invention is not limited to the examples.

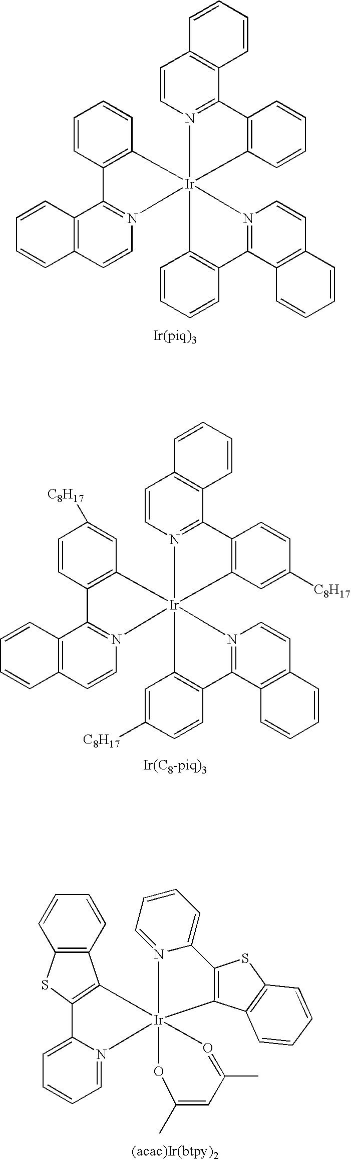

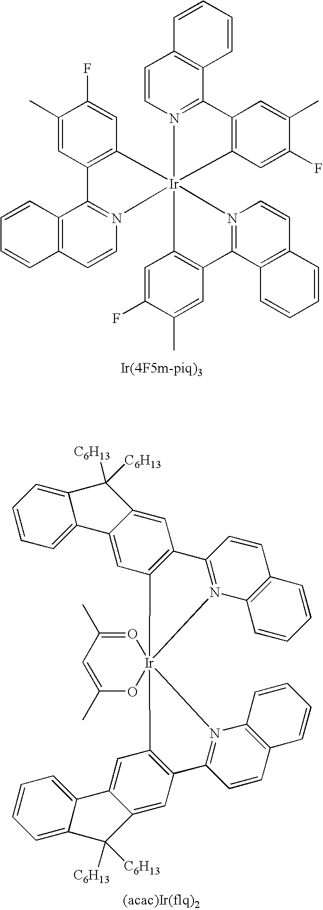

In addition, examples of the singlet light emitting material include the following compounds. However, the present invention is not limited to the examples.

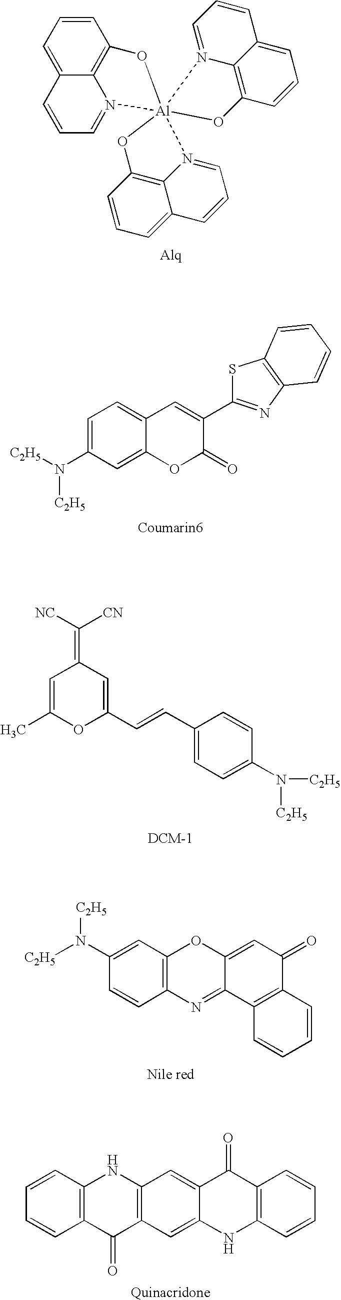

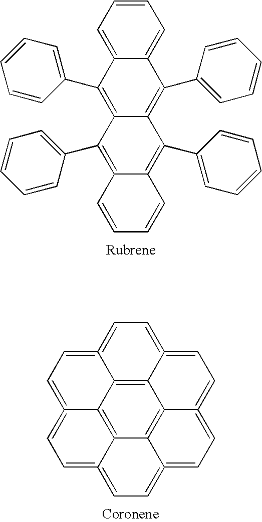

In addition, the oligofluorene compound represented by the general formula (I) can also be used as a material of which, for example, each of the electron injecting layer 5 and the electron transporting layer 8 shown in FIGS. 1 to 3 is formed because the oligofluorene compound has electron transporting property.

Next, a material except the oligofluorene compound of which each layer of the organic light emitting device of the present invention is formed will be described.

A material of which the substrate 1 is formed is, for example, glass, ceramic, a semiconductor, a metal, or a plastic, but is not particularly limited to them. Here, when the organic light emitting device is of a bottom emission type, a transparent substrate such as a glass substrate is used. On the other hand, when the organic light emitting device is of a top emission type, a metal substrate is used, or a cathode material such as Ag is formed on a glass substrate or the like so as to form a mirror structure in order that light may be prevented from leaking to the lower portion of the substrate. In addition, the luminescent color of the device can be controlled by using a color filter film, a fluorescent color conversion filter film, a dielectric reflective film, or the like as the substrate 1. Further, the organic light emitting device can be produced by: producing a thin film transistor (TFT) on the substrate 1; and connecting the substrate to the TFT.

A material forming the anode 2 preferably has as large a work function as possible. Examples of the anode material include a metal such as gold, platinum, silver, copper, nickel, palladium, cobalt, selenium, vanadium, tungsten or chromium. In addition, each of alloys thereof and metal oxides such as tin oxide, zinc oxide, indium oxide, indium tin oxide (ITO), and indium zinc oxide, and halides thereof such as CuI may be used. Further, a conductive polymer such as polyaniline, polypyrrole, polythiophene, or polyphenylene sulfide may also be used. Each of those electrode substances may be used alone, or two or more of them may be used in combination. Further, the anode 2 may adopt a single layer construction or a multilayer construction.

Any material can be used for forming the hole injecting layer 3 as long as the material has hole injecting property. A material which: is used upon production of an application type organic light emitting device; and has resistance to a solvent for dissolving a material of which the light emitting layer 4 is formed is preferable.

Examples of the material of which the hole injecting layer 3 is formed include the following compounds. However, the present invention is not limited to the examples.

### (Polymer-Based Hole Transportable Compound)

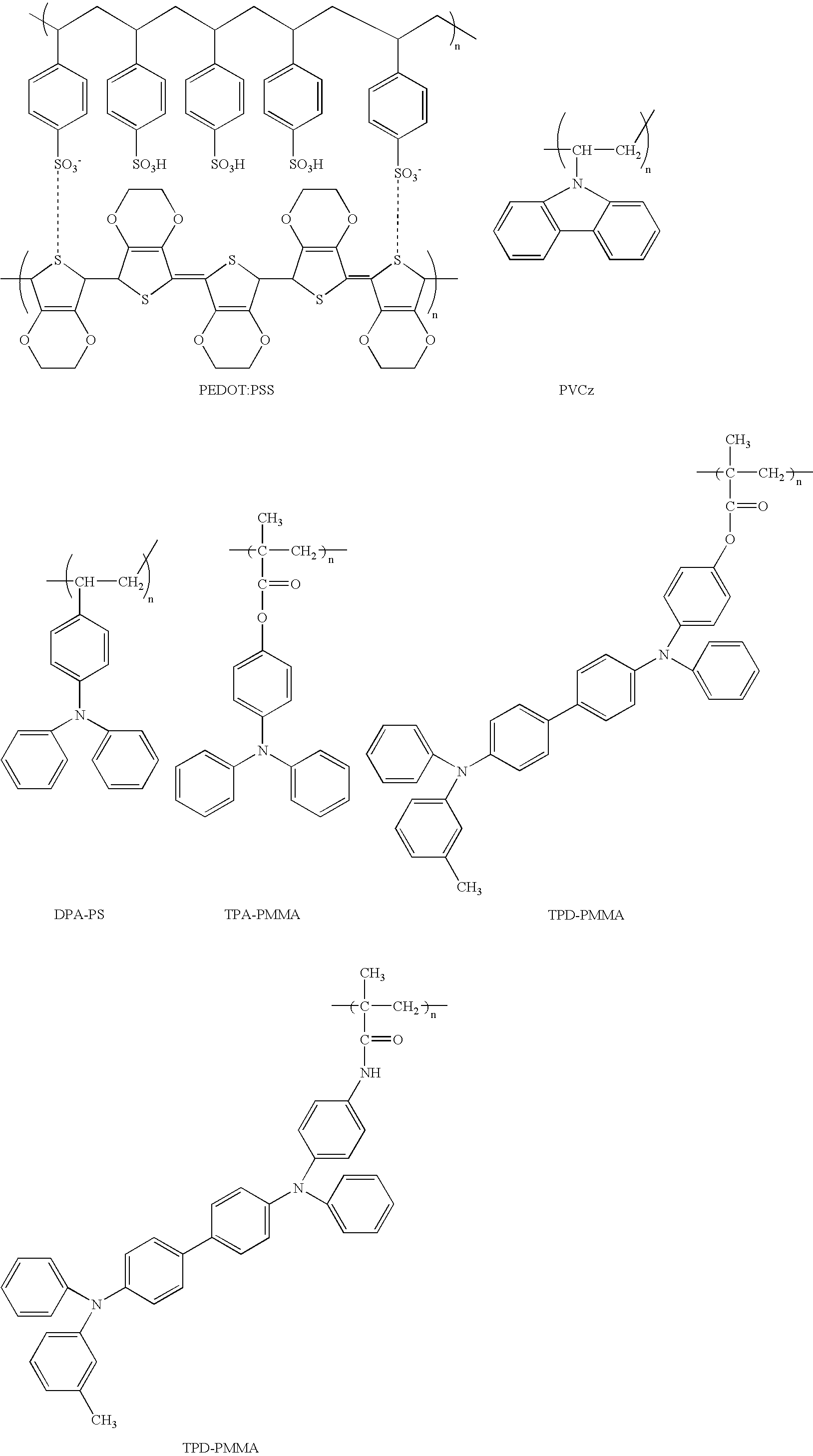

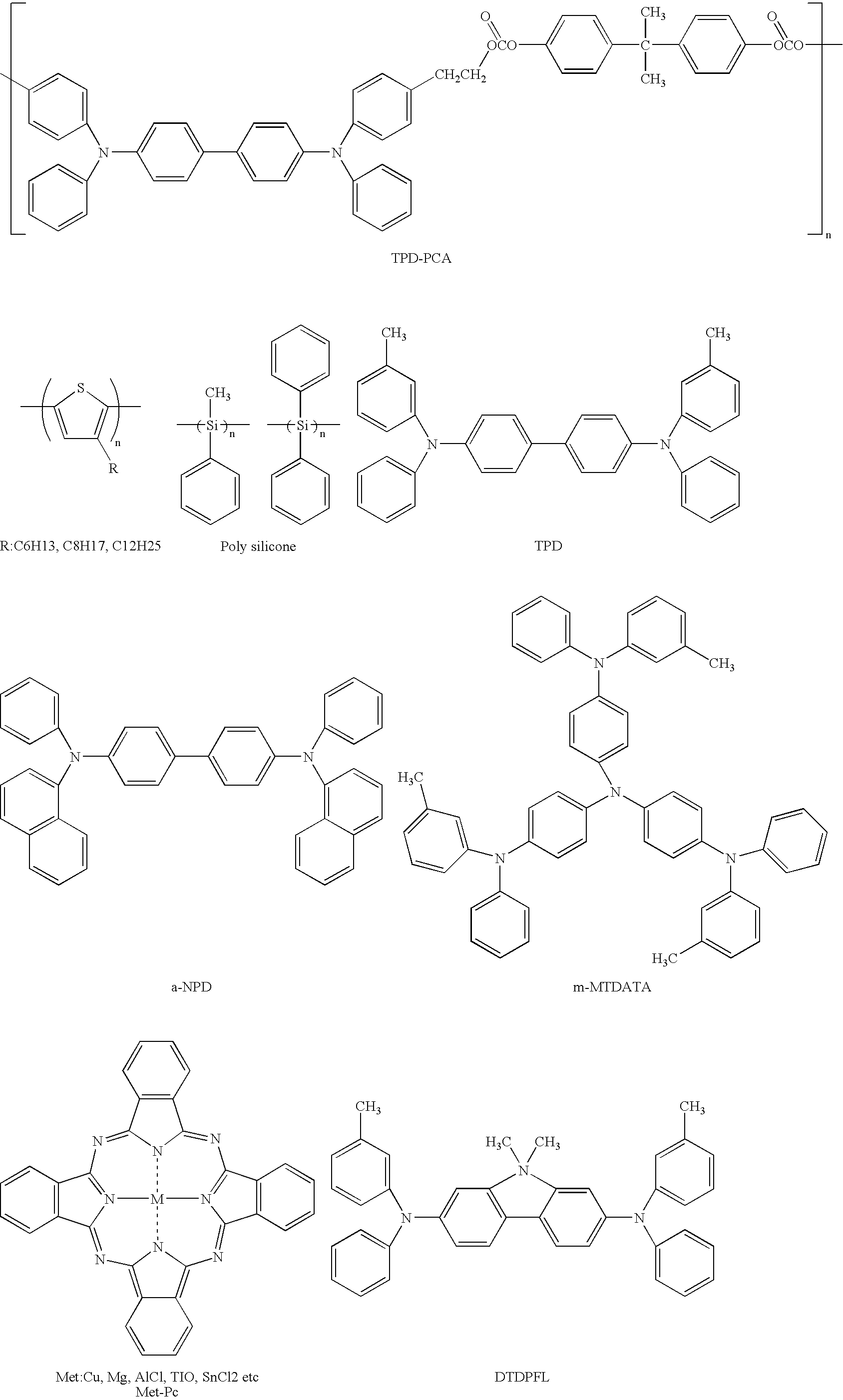

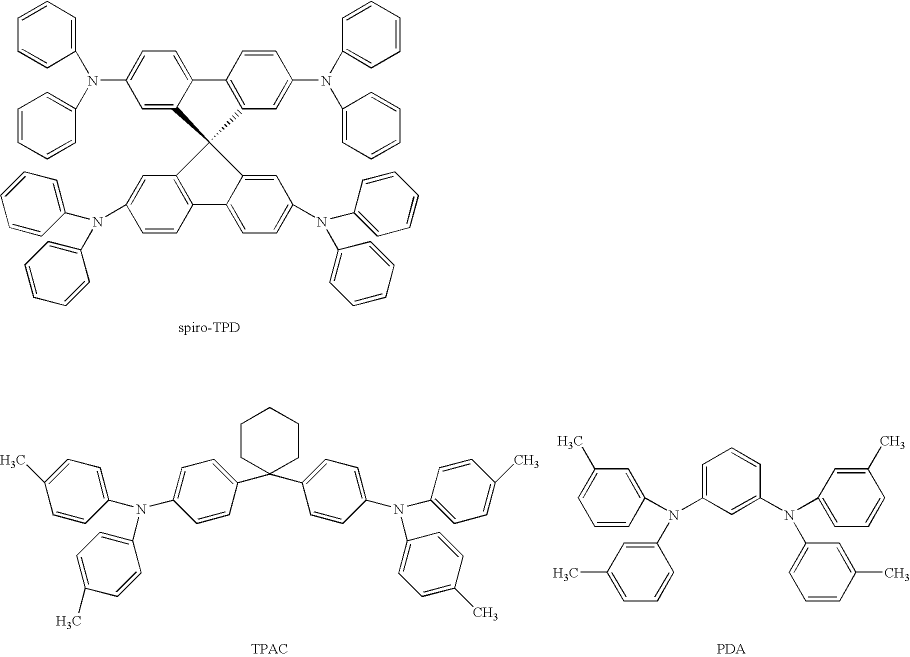

A material of which the electron injecting layer 5 is formed is, for example, a fluoride, carbonate compound, or oxide of an alkali metal or alkaline earth metal such as LiF, CsCO₃, or CaO. An organic compound having electron transporting property is also permitted.

Examples of the material of which the electron injecting layer 5 is formed include the following compounds. However, the present invention is not limited to the examples.

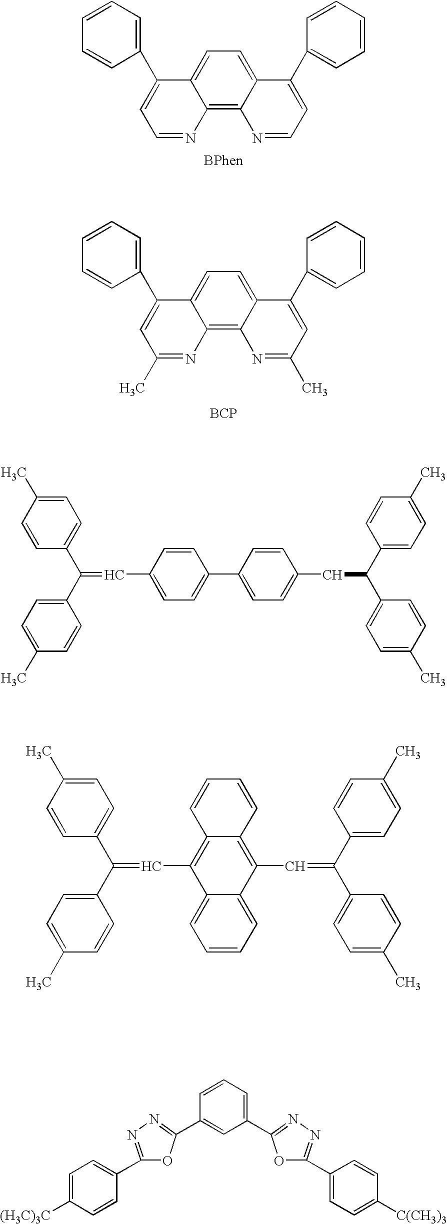

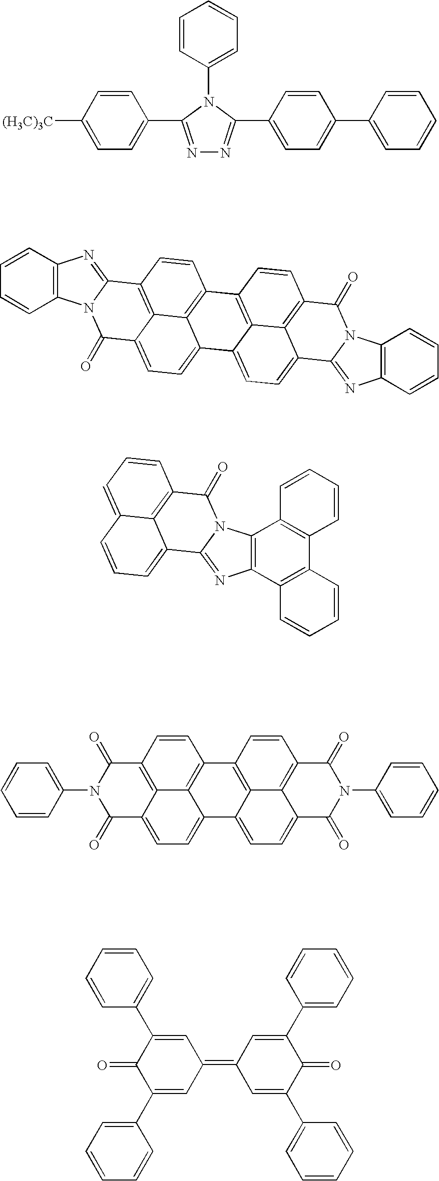

A material forming the cathode 6 preferably has a small work function. Examples of the cathode material which can be used include a metal such as lithium, sodium, potassium, calcium, magnesium, aluminum, indium, ruthenium, titanium, manganese, yttrium, silver, lead, tin, chromium or alloys thereof. Specific examples of the alloys include lithium-indium, sodium-potassium, magnesium-silver, aluminum-lithium, aluminum-magnesium, or magnesium-indium. A metal oxide such as indium tin oxide (ITO) may also be used. Each of those electrode substances may be used alone, or two or more of them may be used in combination. Further, the cathode 6 may adopt a single layer construction or a multilayer construction.

At least one of the anode 2 and the cathode 6 is desirably transparent or semi-transparent.

A material of which the hole transporting layer 7 shown in FIG. 2 is formed and a material of which the electron transporting layer 8 shown in FIG. 2 is formed have only to have hole transporting property and electron transporting property, respectively, and a known hole transportable material or electron transportable material can be used.

In addition, a material of which the electron blocking layer 9 shown in FIG. 3 is formed has only to be a material that blocks an electron trying to move from the light emitting layer 4 to the anode 2. For example, a polymer-based hole transportable compound such as the mixture PEDOT:PSS described above, or a low-molecular-weight-based hole transportable compound such as TPD can be used. In addition to the foregoing, for example, an inorganic insulator layer made of SiO₂, SiN, or the like, or an organic silicon-based polymer such as siloxane can also be used.

It should be noted that the produced organic light-emitting device may be provided with a protective layer or a sealing layer for the purpose of preventing the device from contacting with, for example, oxygen or moisture. Examples of the protective layer include: an inorganic material film such as a diamond thin film, a metal oxide, or a metal nitride; a polymer film such as a fluorine resin, polyparaxylene, polyethylene, a silicone resin, or a polystyrene resin; and a photocurable resin. In addition, the device itself may be covered with, for example, glass, a gas impermeable film, or a metal, and packaged with an appropriate sealing resin.

In the organic light emitting device of the present invention, the light emitting layer 4 may be formed by each of a vacuum vapor deposition method and an application method; the layer is preferably formed by the application method because the oligofluorene compound represented by the general formula (I) has high solubility in an organic solvent. Here, examples of the application method include a spin coating method, a slit coater method, a printing method, an inkjet method, a dispense method, and a spray method.

Next, an ink composition of the present invention will be described.

The ink composition of the present invention contains at least one kind of the oligofluorene compound represented by the following general formula (I).

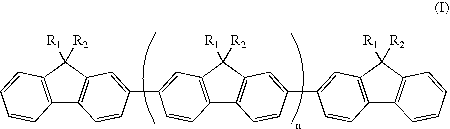

The oligofluorene compound represented by the general formula (I) can be used in the ink composition because the compound has good solubility in an organic solvent. In addition, the use of the ink composition of the present invention enables the production of a layer formed of an organic compound of which the organic light emitting device of the present invention is formed, in particular, the light emitting layer 4 by an application method, whereby a large-area device can be easily produced at a relatively low cost.

Examples of the solvent dissolving the oligofluorene compound represented by the general formula (1) include toluene, xylene, mesitylene, dioxane, tetralin, n-dodecylbenzene, methylnaphthalene, tetrahydrofuran, diglyme, 1,2-dichlorobenzene, and 1,2-dicholoropropane.

In addition, the ink composition of the present invention may contain a compound serving as an additive as well as the oligofluorene compound. Examples of the compound serving as an additive include the above-mentioned known hole transportable material, light emitting material, and electron transportable material.

The concentration of the fluorene compound represented by the general formula (I) in the ink composition is preferably 0.05 wt % or more to 20 wt % or less, or more preferably 0.1 wt % or more to 5 wt % or less with respect to the entirety of the composition.

A display apparatus such as a display can be built by forming the organic light emitting device of the present invention on an electrode formed in a pixel pattern. A display apparatus including the organic light emitting device of the present invention consumes small power by virtue of its high efficiency, and has a long lifetime.

Hereinafter, the present invention will be described more specifically by way of examples. However, the present invention is not limited to the examples.

### Synthesis Example 1

### Synthesis of Exemplified Compound No. 1

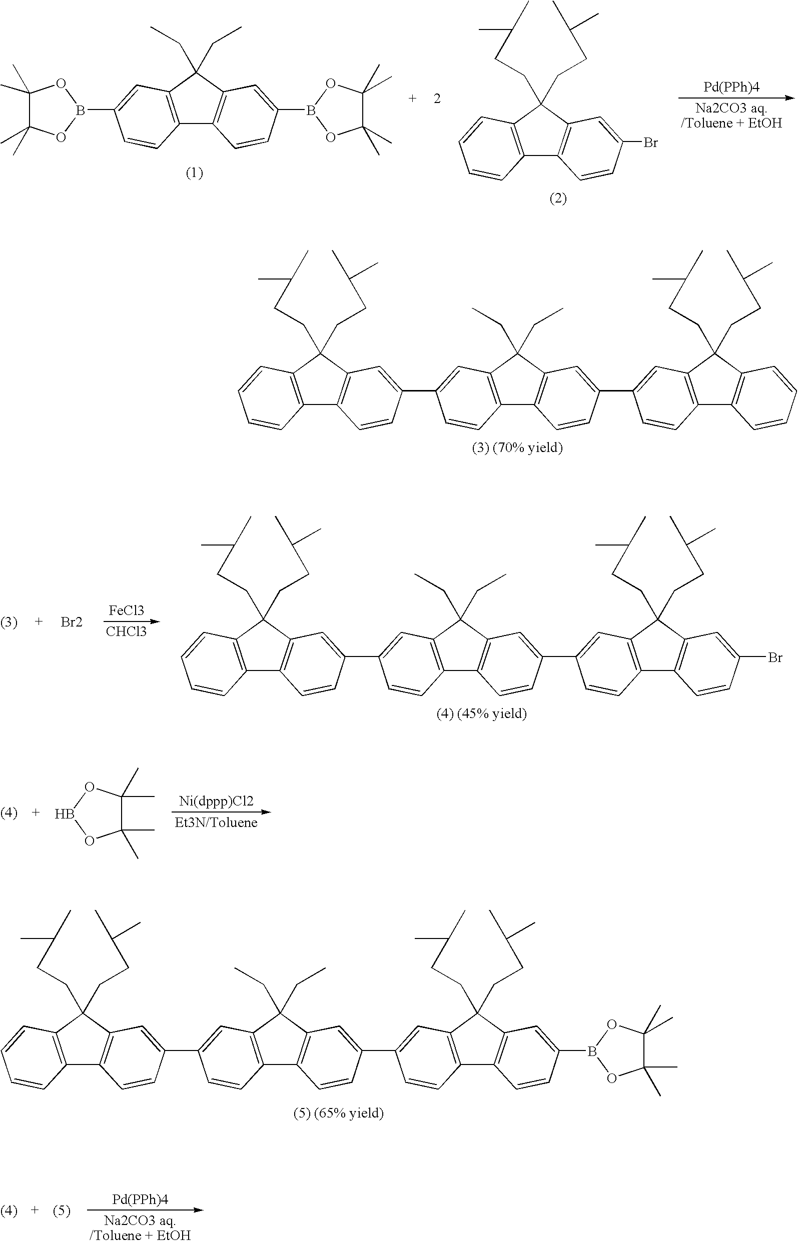 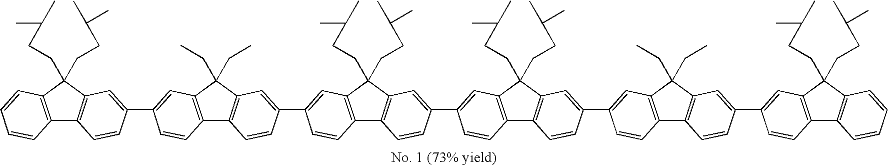 [0088] (1) 20 g (42.2 mmol) of a dipinacol body (1), 39.0 g (101 mmol) of a monobromo body (2), 600 ml of toluene, and 200 ml of ethanol were loaded into a 2,000-ml three-necked flask. Next, an aqueous solution prepared by dissolving 40 g of sodium carbonate in 200 ml of water was dropped to the reaction solution while the reaction solution was stirred in a nitrogen atmosphere at room temperature. Subsequently, 2.4 g (2.2 mmol) of tetrakis(triphenylphosphine)palladium(0) were added to the reaction solution. Next, the reaction solution was stirred at room temperature for 30 minutes. After that, the temperature of the reaction solution was increased to 77° C., and then the reaction solution was stirred for 5 hours. After the completion of the reaction, the organic layer of the reaction solution was extracted with chloroform and dried with anhydrous sodium sulfate. After the solvent had been removed by distillation under reduced pressure, the remainder was purified by silica gel column chromatography (developing solvent: a mixed solvent of hexane and toluene), whereby 24.6 g of a fluorene trimer (3) as a white crystal were obtained (70% yield).
(2) 8.0 g (9.6 mmol) of the fluorene trimer (3) and 200 ml of chloroform were loaded into a 500-ml three-necked flask. 0.08 g (0.48 mmol) of iron chloride was added to the reaction solution while the temperature of the reaction solution was kept at 5° C. Next, a solution prepared by dissolving 1.5 g (9.6 mmol) of bromine in 40 ml of chloroform was dropped to the reaction solution. After that, the temperature of the reaction solution was increased to room temperature, and then the reaction solution was stirred for 8 hours. After the completion of the reaction, the organic layer of the reaction solution was extracted with chloroform, washed with an aqueous solution of sodium thiosulfate, and dried with anhydrous sodium sulfate. After the solvent had been removed by distillation under reduced pressure, the remainder was purified by silica gel column chromatography (developing solvent: a mixed solvent of heptane and toluene), whereby 3.9 g of a monobromofluorene trimer (4) as a white crystal were obtained (45% yield).
(3) 2.0 g (2.2 mmol) of the monobromofluorene trimer (4) and 80 ml of toluene were loaded into a 200-ml three-necked flask. Next, 0.62 ml (4.4 mmol) of triethylamine and 0.12 g (0.22 mmol) of (1,3-diphenylphosphinopropane)dichloronickel were added to the reaction solution while the reaction solution was stirred in a nitrogen atmosphere at room temperature. Next, 0.64 ml (4.4 mmol) of 4,4,5,5-tetramethyl-1,3,2-dioxaborolane was dropped to the reaction solution. After that, the temperature of the reaction solution was increased to 100° C., and then the reaction solution was stirred for 8 hours. After the completion of the reaction, the organic layer of the reaction solution was extracted with ethyl acetate and dried with anhydrous sodium sulfate. After the solvent had been removed by distillation under reduced pressure, the remainder was purified by silica gel column chromatography (developing solvent: a mixed solvent of hexane and toluene), whereby 1.37 g of a monopinacolfluorene trimer (5) as a white crystal were obtained (65% yield).
(4) 0.86 g (0.95 mmol) of the monobromofluorene trimer (4), 1.0 g (1.0 mmol) of the monopinacolfluorene trimer (5), 80 ml of toluene, and 40 ml of ethanol were loaded into a 200-ml three-necked flask. Next, an aqueous solution prepared by dissolving 2 g of sodium carbonate in 10 ml of water was dropped to the reaction solution while the reaction solution was stirred in a nitrogen atmosphere at room temperature. Subsequently, 0.06 g (0.05 mmol) of tetrakis(triphenylphosphine)palladium(0) was added to the reaction solution. Next, the reaction solution was stirred at room temperature for 30 minutes. After that, the temperature of the reaction solution was increased to 77° C., and then the reaction solution was stirred for 5 hours. After the completion of the reaction, the organic layer of the reaction solution was extracted with chloroform and dried with anhydrous sodium sulfate. After the solvent had been removed by distillation under reduced pressure, the remainder was purified by silica gel column chromatography (developing solvent: a mixed solvent of hexane and toluene), whereby 1.15 g of Exemplified Compound No. 1 as a yellowish white crystal were obtained (73% yield).

The glass transition temperature of the resultant compound was measured with a differential scanning calorimeter (DSC). Table 1 shows the result.

### Synthesis Example 2

### Synthesis of Exemplified Compound No. 5

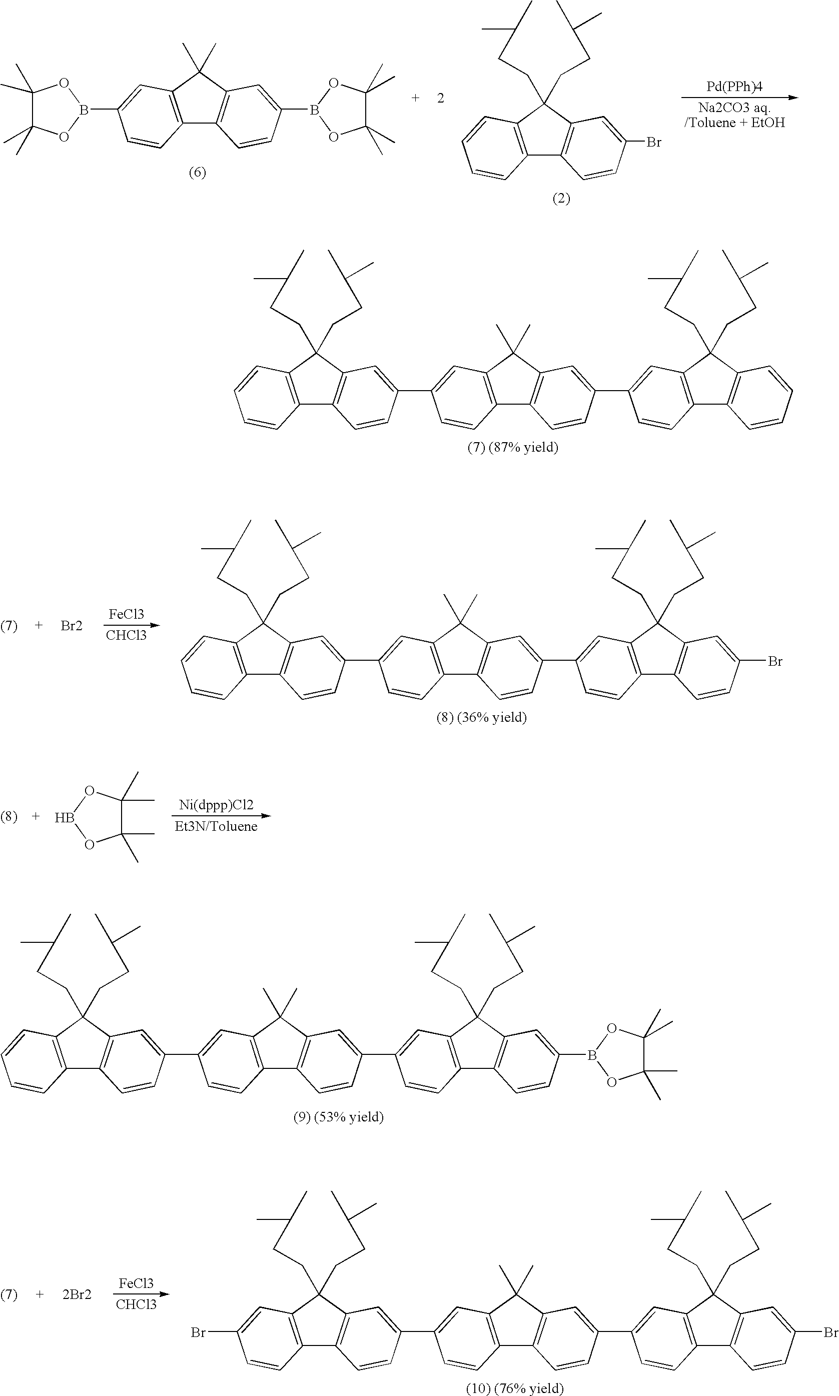 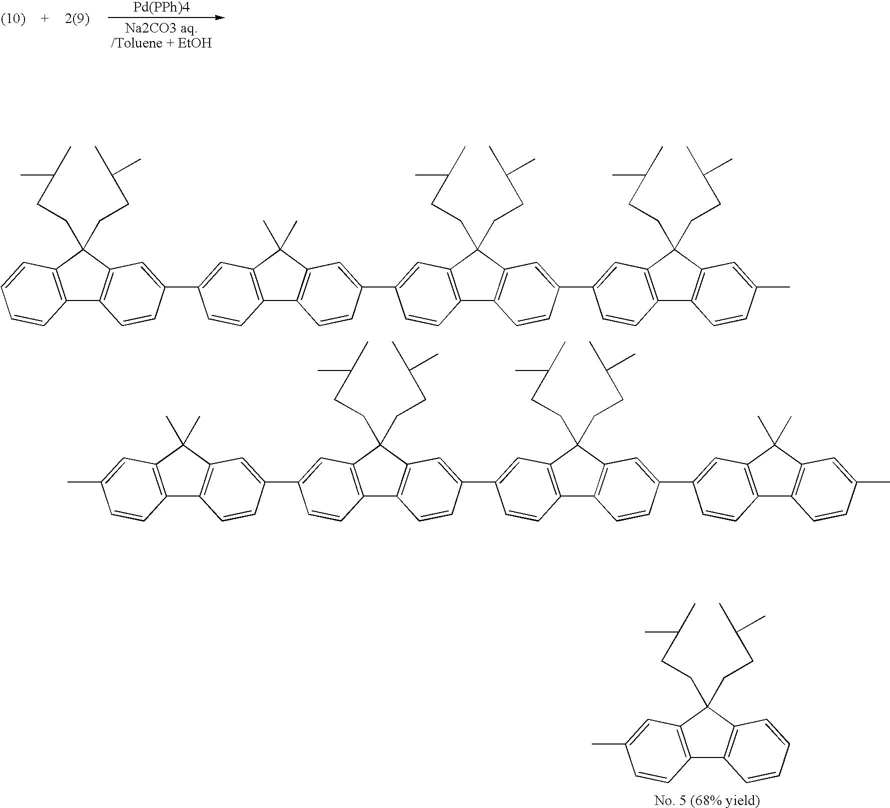 [0094] (1) A fluorene trimer (7) was synthesized from a dipinacol body (6) in the same manner as in the step (1) of Synthesis Example 1. A monobromofluorene trimer (8) was synthesized from the fluorene trimer (7) in the same manner as in the step (2) of Synthesis Example 1. A monopinacolfluorene trimer (9) was synthesized from the monobromofluorene trimer (8) in the same manner as in the step (3) of Synthesis Example 1.
(2) 10.0 g (12.5 mmol) of the fluorene trimer (7) and 200 ml of chloroform were loaded into a 500-ml three-necked flask. 0.1 g (0.63 mmol) of iron chloride was added to the reaction solution while the temperature of the reaction solution was kept at 5° C. Next, a solution prepared by dissolving 4.4 g (27.3 mmol) of bromine in 50 ml of chloroform was dropped to the reaction solution. After that, the temperature of the reaction solution was increased to room temperature, and then the reaction solution was stirred for 8 hours. After the completion of the reaction, the organic layer of the reaction solution was extracted with chloroform, washed with an aqueous solution of sodium thiosulfate, and dried with anhydrous sodium sulfate. After the solvent had been removed by distillation under reduced pressure, the remainder was purified by silica gel column chromatography (developing solvent: a mixed solvent of heptane and toluene), whereby 9.1 g of a dibromofluorene trimer (10) as a white crystal were obtained (76% yield).
(3) 1.0 g (1.04 mmol) of the dibromofluorene trimer (10), 2.1 g (2.29 mmol) of the monopinacolfluorene trimer (9), 80 ml of toluene, and 40 ml of ethanol were loaded into a 200-ml three-necked flask. Next, an aqueous solution prepared by dissolving 2 g of sodium carbonate in 10 ml of water was dropped to the reaction solution while the reaction solution was stirred in a nitrogen atmosphere at room temperature. Subsequently, 0.06 g (0.05 mmol) of tetrakis(triphenylphosphine)palladium(0) was added to the reaction solution. Next, the reaction solution was stirred at room temperature for 30 minutes. After that, the temperature of the reaction solution was increased to 77° C., and then the reaction solution was stirred for 5 hours. After the completion of the reaction, the organic layer of the reaction solution was extracted with chloroform and dried with anhydrous sodium sulfate. After the solvent had been removed by distillation under reduced pressure, the remainder was purified by silica gel column chromatography (developing solvent: a mixed solvent of hexane and toluene), whereby 1.7 g of Exemplified Compound No. 5 as a yellowish white crystal were obtained (68% yield).

The glass transition temperature of the resultant compound was measured with a differential scanning calorimeter (DSC). Table 1 shows the result.

### Synthesis Example 3

### Synthesis of Exemplified Compound No. 6

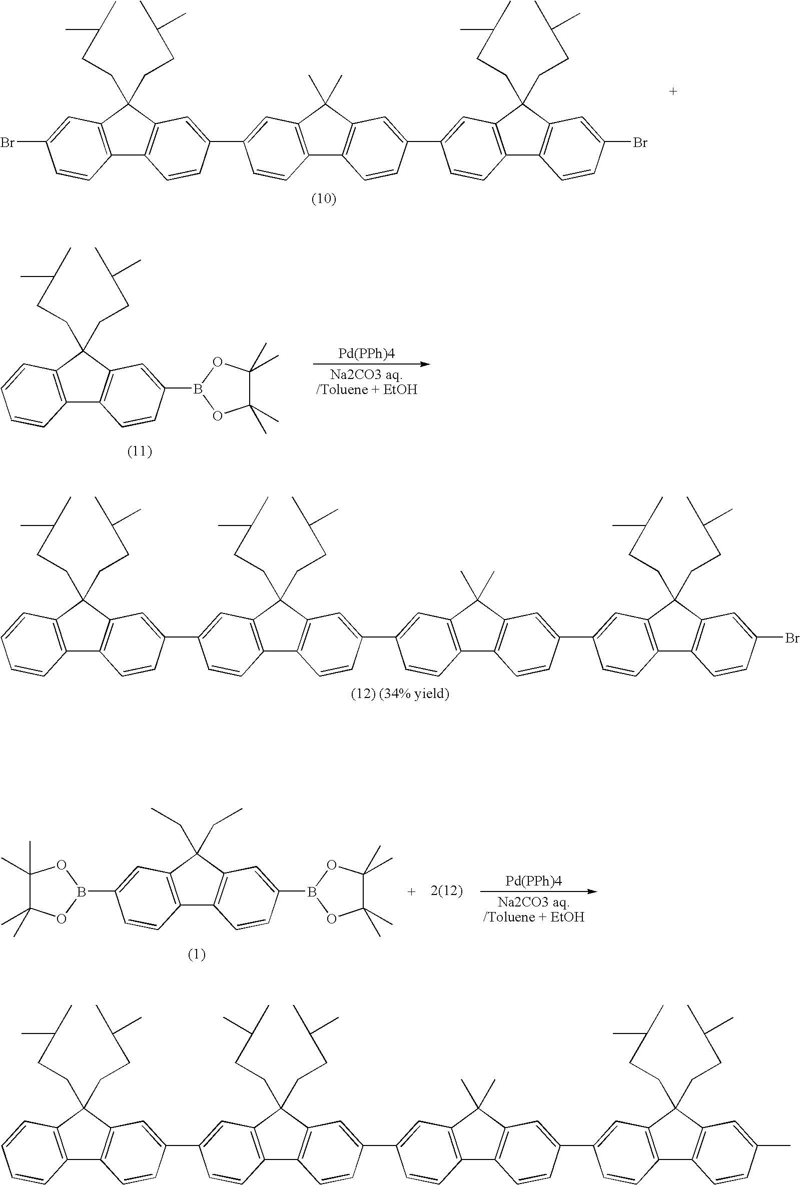 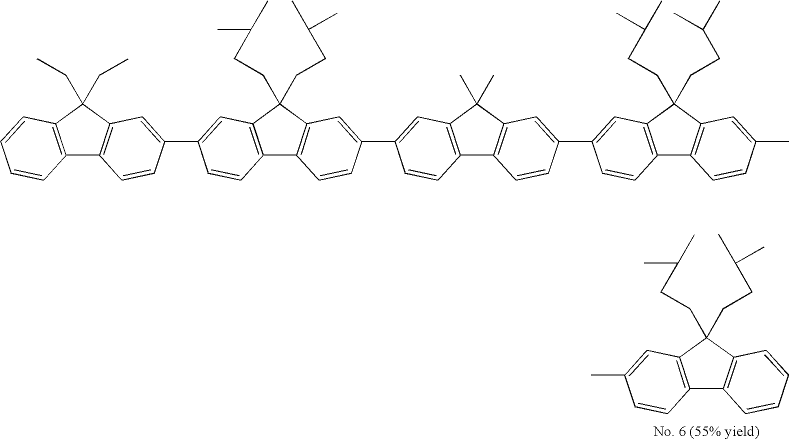 [0099] (1) 5.0 g (5.2 mmol) of the dibromofluorene trimer (10), 2.2 g (5.2 mmol) of the monopinacol body (11), 150 ml of toluene, and 50 ml of ethanol were loaded into a 300-ml three-necked flask. Next, an aqueous solution prepared by dissolving 10 g of sodium carbonate in 50 ml of water was dropped to the reaction solution while the reaction solution was stirred in a nitrogen atmosphere at room temperature. Subsequently, 0.3 g (0.26 mmol) of tetrakis(triphenylphosphine)palladium(0) was added to the reaction solution. Next, the reaction solution was stirred at room temperature for 30 minutes. After that, the temperature of the reaction solution was increased to 77° C., and then the reaction solution was stirred for 5 hours. After the completion of the reaction, the organic layer of the reaction solution was extracted with chloroform and dried with anhydrous sodium sulfate. After the solvent had been removed by distillation under reduced pressure, the remainder was purified by silica gel column chromatography (developing solvent: a mixed solvent of hexane and toluene), whereby 2.1 g of monobromofluorene tetramer (12) as a white crystal were obtained (34% yield).
(2) 0.5 g (1.05 mmol) of a dipinacol body (1), 2.8 g (2.32 mmol) of the monobromofluorene tetramer (12), 80 ml of toluene, and 30 ml of ethanol were loaded into a 200-ml three-necked flask. Next, an aqueous solution prepared by dissolving 2 g of sodium carbonate in 10 ml of water was dropped to the reaction solution while the reaction solution was stirred in a nitrogen atmosphere at room temperature. Subsequently, 0.06 g (0.05 mmol) of tetrakis(triphenylphosphine)palladium(0) was added to the reaction solution. Next, the reaction solution was stirred at room temperature for 30 minutes. After that, the temperature of the reaction solution was increased to 77° C., and then the reaction solution was stirred for 5 hours. After the completion of the reaction, the organic layer of the reaction solution was extracted with chloroform and dried with anhydrous sodium sulfate. After the solvent had been removed by distillation under reduced pressure, the remainder was purified by silica gel column chromatography (developing solvent: a mixed solvent of hexane and toluene), whereby 1.4 g of Exemplified Compound No. 6 as a yellowish white crystal were obtained (55% yield).

The glass transition temperature of the resultant compound was measured with a differential scanning calorimeter (DSC). Table 1 shows the result.

### Synthesis Example 4

### Synthesis of Exemplified Compound No. 10

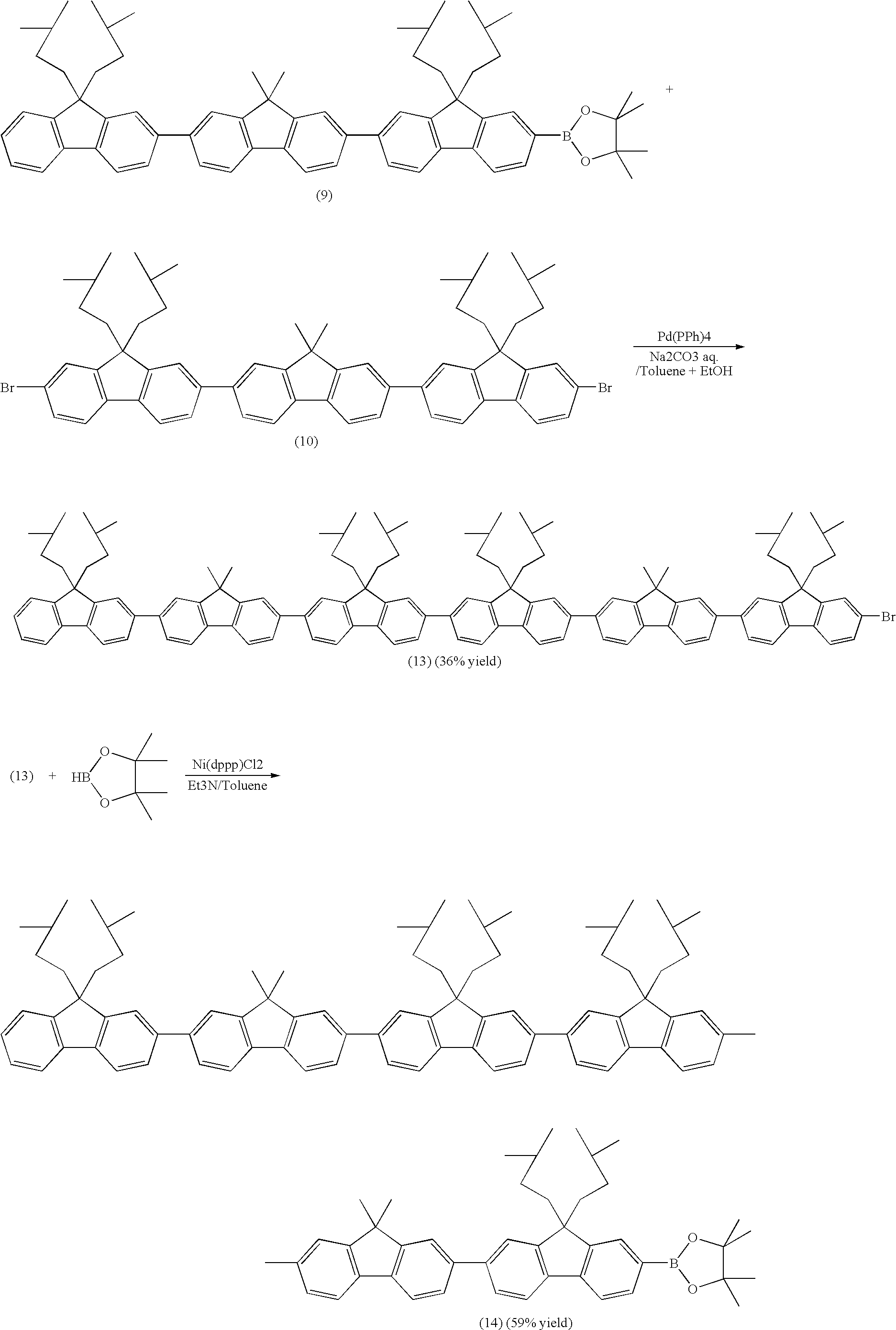 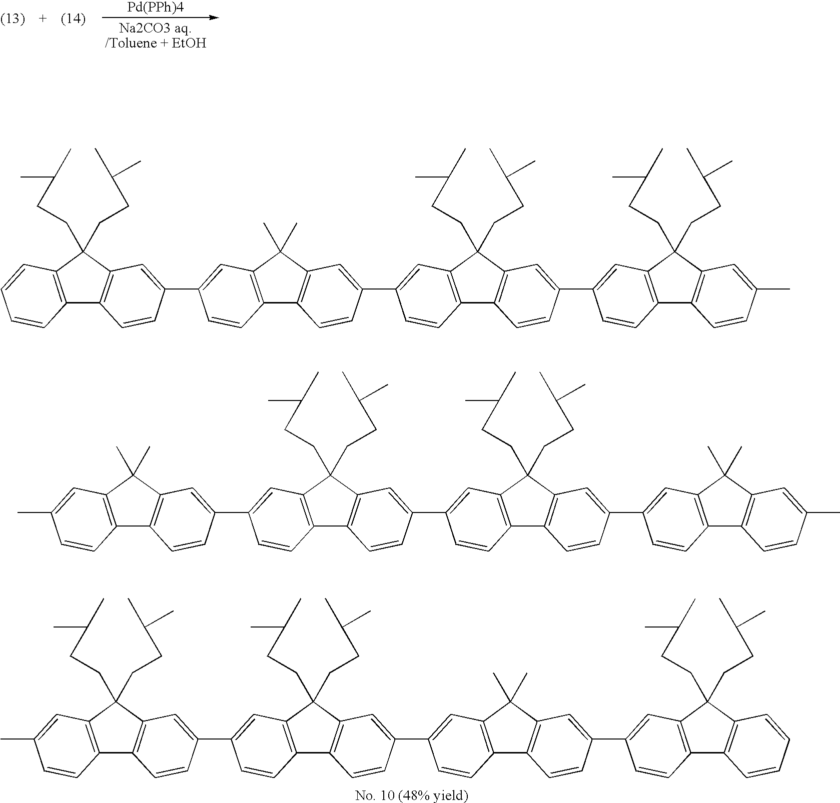 [0103] (1) 9.7 g (10.4 mmol) of the monopinacolfluorene trimer (9), 10 g (10.4 mmol) of the dibromofluorene trimer (10), 250 ml of toluene, and 80 ml of ethanol were loaded into a 500-ml three-necked flask. Next, an aqueous solution prepared by dissolving 20 g of sodium carbonate in 100 ml of water was dropped to the reaction solution while the reaction solution was stirred in a nitrogen atmosphere at room temperature. Subsequently, 0.58 g (0.5 mmol) of tetrakis(triphenylphosphine)palladium(0) was added to the reaction solution. Next, the reaction solution was stirred at room temperature for 30 minutes. After that, the temperature of the reaction solution was increased to 77° C., and then the reaction solution was stirred for 5 hours. After the completion of the reaction, the organic layer of the reaction solution was extracted with chloroform and dried with anhydrous sodium sulfate. After the solvent had been removed by distillation under reduced pressure, the remainder was purified by silica gel column chromatography (developing solvent: a mixed solvent of hexane and toluene), whereby 6.3 g of a monobromofluorene hexamer (13) as a yellowish white crystal were obtained (36% yield).
(2) 4.0 g (2.4 mmol) of the monobromofluorene hexamer (13) and 100 ml of toluene were loaded into a 300-ml three-necked flask. Next, 0.5 ml (3.6 mmol) of triethylamine and 0.13 g (0.24 mmol) of (1,3-diphenylphosphinopropane)dichloronickel were added to the reaction solution while the reaction solution was stirred in a nitrogen atmosphere at room temperature. Next, 0.52 ml (3.6 mmol) of 4,4,5,5-tetramethyl-1,3,2-dioxaborolane was dropped to the reaction solution. After that, the temperature of the reaction solution was increased to 100° C., and then the reaction solution was stirred for 10 hours. After the completion of the reaction, the organic layer of the reaction solution was extracted with ethyl acetate and dried with anhydrous sodium sulfate. After the solvent had been removed by distillation under reduced pressure, the remainder was purified by silica gel column chromatography (developing solvent: a mixed solvent of hexane and toluene), whereby 2.4 g of a monopinacolfluorene hexamer (14) as a yellowish white crystal were obtained (59% yield).
(3) 1.0 g (0.59 mmol) of the monobromofluorene hexamer (13), 1.03 g (0.59 mmol) of the monopinacolfluorene hexamer (14), 80 ml of toluene, and 30 ml of ethanol were loaded into a 200-ml three-necked flask. Next, an aqueous solution prepared by dissolving 1.2 g of sodium carbonate in 6 ml of water was dropped to the reaction solution while the reaction solution was stirred in a nitrogen atmosphere at room temperature. Subsequently, 0.03 g (0.03 mmol) of tetrakis(triphenylphosphine)palladium(0) was added to the reaction solution. Next, the reaction solution was stirred at room temperature for 30 minutes. After that, the temperature of the reaction solution was increased to 77° C., and then the reaction solution was stirred for 5 hours. After the completion of the reaction, the organic layer of the reaction solution was extracted with chloroform and dried with anhydrous sodium sulfate. After the solvent had been removed by distillation under reduced pressure, the remainder was purified by silica gel column chromatography (developing solvent: a mixed solvent of hexane and toluene), whereby 0.91 g of Exemplified Compound No. 10 as a yellowish white crystal was obtained (48% yield).

The glass transition temperature of the resultant compound was measured with a differential scanning calorimeter (DSC). Table 1 shows the result.

TABLE 1

| | | Glass transition |
|---|---|---|
| | Synthesized compound | temperature (° C.) |
| Synthetic | Exemplified Compound | 160 |
| Example 1 | No. 1 | |
| Synthetic | Exemplified Compound | 165 |
| Example 2 | No. 5 | |
| Synthetic | Exemplified Compound | 180 |
| Example 3 | No. 6 | |
| Synthetic | Exemplified Compound | 180 |
| Example 4 | No. 10 | |

For comparison, the glass transition temperature or the like of an oligofluorene derivative represented by the following formula described in S. W. Culligan et al., Advanced Material, 2003, 15, No. 14, p 1176 was also measured with a differential scanning calorimeter (DSC).

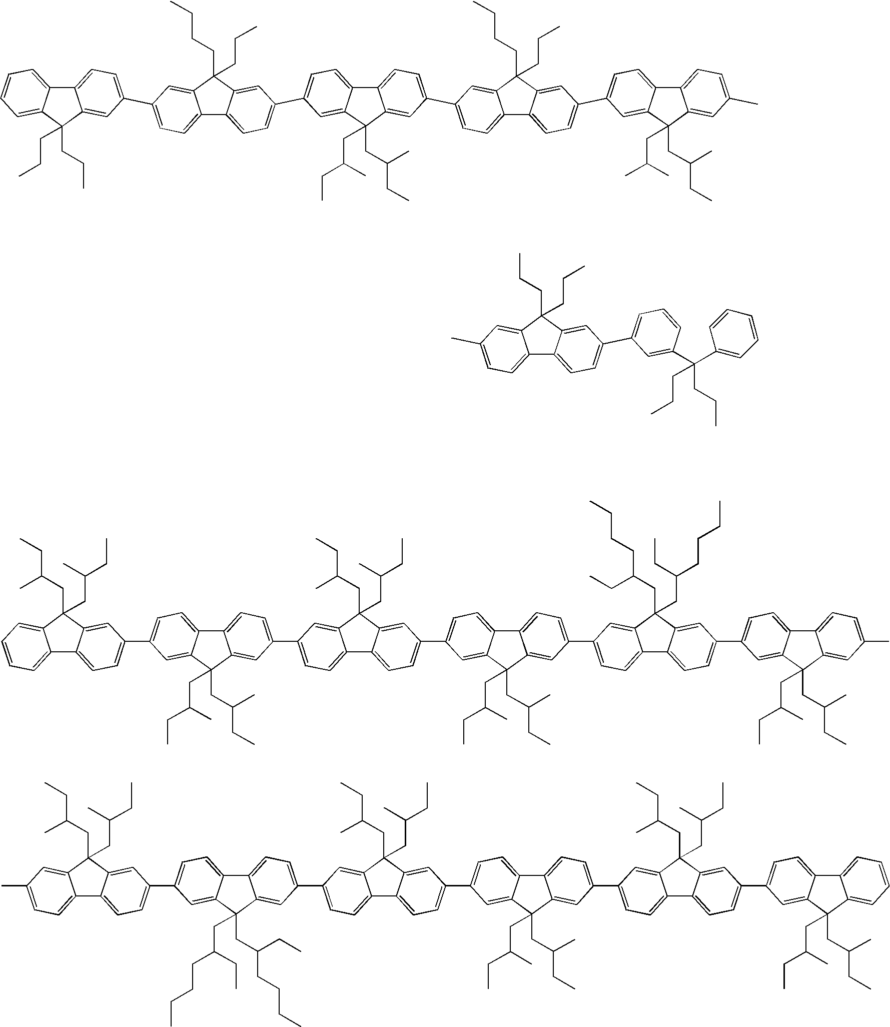

While the above oligofluorene derivative was observed to undergo a phase transition to a nematic liquid crystal phase at around 120° C., none of the oligofluorene compounds obtained in Synthesis Examples 1 to 4 was observed to be turned into liquid crystal. In addition, Table 1 shown above reveals that the glass transition temperature of each of the oligofluorene compounds obtained in Synthesis Examples 1 to 4 is higher than the liquid crystal phase transition temperature (around 120° C.) of the oligofluorene derivative described in S. W. Culligan et al., Advanced Material, 2003, 15, No. 14, p 1176. Accordingly, it was found that each of the oligofluorene compounds obtained in Synthesis Examples 1 to 4 was a compound excellent in heat stability and having high non-liquid crystallinity.

### Example 1

An organic light emitting device shown in FIG. 1 was produced. Materials of which the respective layers are formed to be used in this example are as shown below.

| | |
|---|---|
| Substrate 1: | glass substrate |
| Anode 2: | indium tin oxide (ITO) |
| Hole injecting layer 3: | mixture PEDOT:PSS (PAI- |
| | 4083 manufactured by Baytron) |
| Light emitting layer 4: | Exemplified Compound No. 1 |
| Electron injecting layer 5: | CsCO₃ |
| Cathode 6: | aluminum (Al) |

A specific production process for the organic light emitting device will be described below.

ITO was formed into a film having a thickness of 120 nm by a sputtering method on a glass substrate (the substrate 1), whereby the anode 2 was formed. Next, the glass substrate having the ITO film was subjected to ultrasonic cleaning with acetone and isopropyl alcohol (IPA) sequentially. Subsequently, the substrate was subjected to boil cleaning with IPA, and was then dried. Next, the substrate was subjected to UV/ozone cleaning. The glass substrate thus treated was used as a transparent conductive supporting substrate.

Next, the mixture PEDOT:PSS was formed into a film by a spin coating method on the anode 2 so as to serve as the hole injecting layer 3. It should be noted that the thickness of the hole injecting layer 3 is 30 nm.

Next, a solution of Exemplified Compound No. 1 in chloroform (concentration: 1.0 wt %) was prepared, and then the solution was formed into a film by a spin coating method on the hole injecting layer 3 so as to serve as the light emitting layer 4. It should be noted that the thickness of the light emitting layer 4 is 90 nm.

Next, CsCO₃ was formed into a film having a thickness of 2.4 nm by a vacuum vapor deposition method on the light emitting layer 4 so as to serve as the electron injecting layer 5. In this case, a degree of vacuum upon vapor deposition was 0.5×10⁻⁴ Pa, and a film formation rate was 0.3 nm/sec.

Next, Al was formed into a film having a thickness of 150 nm by a vacuum vapor deposition method so as to serve as the cathode 6. In this case, a degree of vacuum upon vapor deposition was 0.5×10⁻⁴ Pa, and a film formation rate was 1.0 to 1.5 nm/sec.

Finally, the resultant was covered with a protective glass plate in a nitrogen atmosphere and sealed with an acrylic resin-based adhesive.

Thus, the organic light emitting device 10 shown in FIG. 1 was obtained.

A DC voltage of 5.2 V was applied to the resultant device by using the ITO electrode as a positive electrode and the Al electrode as a negative electrode. As a result, it was found that a current flowed into the device at a current density of 116 mA/cm². In addition, the device was observed to emit blue light originating from Exemplified Compound No. 1 and having a luminance of 390 cd/m². The emitted light had chromaticity coordinates NTSC (X, Y) of (0.18, 0.14).

### Example 2

An organic light emitting device was produced in the same manner as in Example 1 except that Exemplified Compound No. 5 was used instead of Exemplified Compound No. 1 upon formation of the light emitting layer 4 in Example 1. The resultant organic light emitting device was evaluated in the same manner as in Example 1. Table 2 shows the results of the evaluation.

### Example 3

An organic light emitting device was produced in the same manner as in Example 1 except that Exemplified Compound No. 6 was used instead of Exemplified Compound No. 1 upon formation of the light emitting layer 4 in Example 1. The resultant organic light emitting device was evaluated in the same manner as in Example 1. Table 2 shows the results of the evaluation.

### Example 4

An organic light emitting device was produced in the same manner as in Example 1 except that Exemplified Compound No. 10 was used instead of Exemplified Compound No. 1 upon formation of the light emitting layer 4 in Example 1. The resultant organic light emitting device was evaluated in the same manner as in Example 1. Table 2 shows the results of the evaluation.

TABLE 2

| | | | | | Maximum |
|---|---|---|---|---|---|
| | | | | | external |
| | Light | | Applied | | quantum |
| | emitting | Current | voltage | Luminance | efficiency |
| | layer | (mA/cm²) | (V) | (cd/m²) | (%) |
| Example 1 | Exemplified | 116 | 5.2 | 390 | 0.58 |
| | Compound | | | | |
| | No. 1 | | | | |
| Example 2 | Exemplified | 114 | 5.1 | 400 | 0.60 |
| | Compound | | | | |
| | No. 5 | | | | |
| Example 3 | Exemplified | 114 | 5.0 | 410 | 0.60 |
| | Compound | | | | |
| | No. 6 | | | | |
| Example 4 | Exemplified | 113 | 5.0 | 415 | 0.65 |
| | Compound | | | | |
| | No. 10 | | | | |

### Example 5

An organic light emitting device was produced in the same manner as in Example 1 except that Exemplified Compound No. 1 was changed to a mixture of Exemplified Compound No. 5 as a host and Ir(C₈-piq)₃ represented by the following formula as a guest upon formation of the light emitting layer 4 in Example 1.

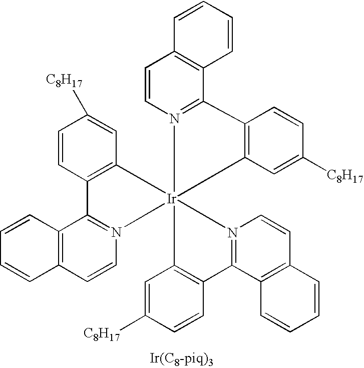

It should be noted that a specific method of forming the light emitting layer 4 will be described below.

First, a solution of Exemplified Compound No. 5 in chloroform (concentration: 1.0 wt %) was prepared. Meanwhile, a solution of Ir(C₈-piq)₃ in chloroform (concentration: 1.0 wt %) was separately prepared. Next, the above two kinds of solutions were mixed in such a manner that the content of Ir(C₈-piq)₃ was 1.0 wt % with respect to the total weight of Exemplified Compound No. 5 and Ir(C₈-piq)₃. The mixed solution was formed into a film by spin application on the hole injecting layer 3, whereby the light emitting layer 4 was formed.

A DC voltage of 8.5 V was applied to the resultant organic light emitting device by using the ITO electrode as a positive electrode and the Al electrode as a negative electrode. As a result, it was found that a current flowed into the device at a current density of 103 mA/cm². In addition, the device was observed to emit red light originating from Ir(C₈-piq)₃ and having a luminance of 5,975 cd/m². In addition, the emitted light had chromaticity coordinates NTSC (X, Y) of (0.65, 0.33). Further, the device was subjected to a durability test with its initial luminance set to 1,000 cd/m². As a result, the time required for the luminance to reduce in half was about 350 hours.

### Example 6

An organic light emitting device was produced in the same manner as in Example 5 except that Exemplified Compound No. 6 was used instead of Exemplified Compound No. 5 as a host in Example 5. The resultant device was evaluated in the same manner as in Example 5. Table 3 shows the results of the evaluation.

### Example 7

An organic light emitting device was produced in the same manner as in Example 5 except that a solution of each of Exemplified Compound No. 5 and Ir(C₈-piq)₃ was prepared by using 1,2-dichloropropane instead of chloroform as a solvent in Example 5. The resultant device was evaluated in the same manner as in Example 5. Table 3 shows the results of the evaluation.

### Example 8

An organic light emitting device was produced in the same manner as in Example 5 except that Exemplified Compound No. 6 was used instead of Exemplified Compound No. 5 as a host in Example 7. The resultant device was evaluated in the same manner as in Example 5. Table 3 shows the results of the evaluation.

### Comparative Example 1

An organic light emitting device was produced in the same manner as in Example 5 except that an oligofluorene compound (A) represented by the following formula was used instead of Exemplified Compound No. 5 as a host in Example 5.

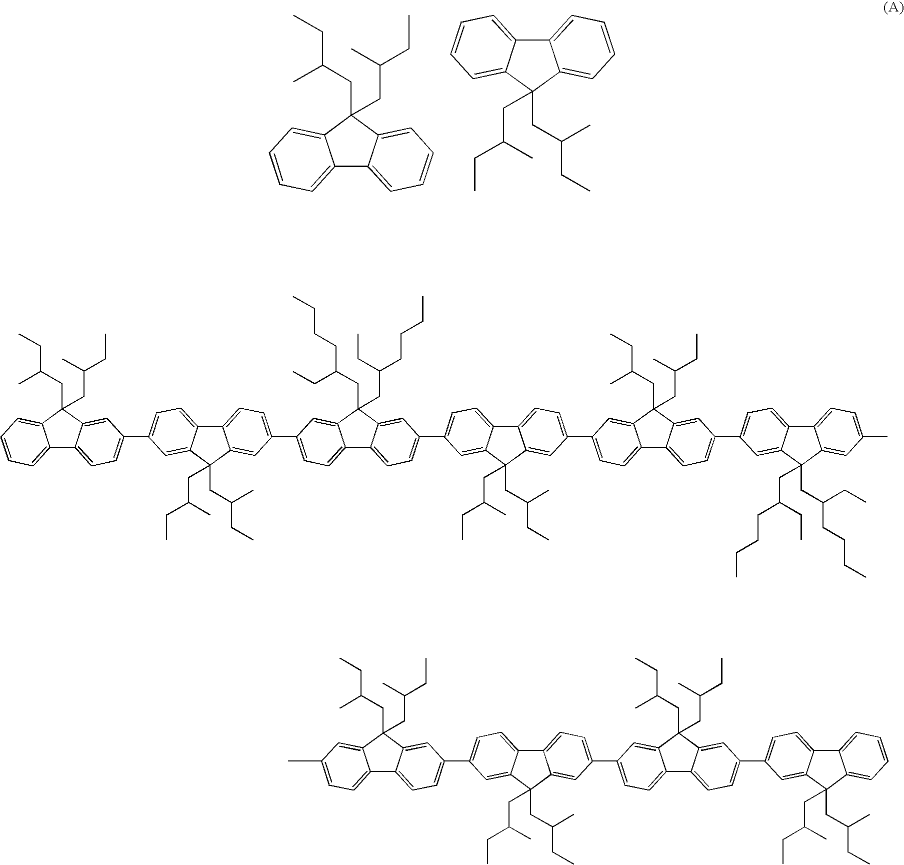

The resultant device was evaluated in the same manner as in Example 5. A DC voltage of 10 V was applied to the device of Comparative Example 1 by using the ITO electrode as a positive electrode and the Al electrode as a negative electrode. As a result, it was found that a current flowed into the device at a current density of 98 mA/cm². In addition, the device was observed to emit red light originating from Ir(C₈-piq)₃ and having a luminance of 3,200 cd/m². The emitted light had chromaticity coordinates NTSC (X, Y) of (0.65, 0.33). In addition, the device was subjected to a durability test with its initial luminance set to 1,000 cd/m². As a result, the time required for the luminance to reduce in half was about 25 hours.

TABLE 3

| | | | | | | Maximum |
|---|---|---|---|---|---|---|
| | | | | | | external |
| | | | | Applied | | quantum |
| | | | Current | voltage | Luminance | efficiency |
| | Host | Solvent | (mA/cm²) | (V) | (cd/m²) | (%) |
| Example 5 | Exemplified | Chloroform | 103 | 8.5 | 5975 | 7.5 |
| | Compound | | | | | |
| | No. 5 | | | | | |
| Example 6 | Exemplified | Chloroform | 96 | 7.0 | 5315 | 9.3 |
| | Compound | | | | | |
| | No. 6 | | | | | |
| Example 7 | Exemplified | 1,2- | 103 | 7.5 | 4167 | 5.0 |
| | Compound | dichloropropane | | | | |
| | No. 5 | | | | | |
| Example 8 | Exemplified | 1,2- | 100 | 6.8 | 4300 | 6.3 |
| | Compound | dichloropropane | | | | |
| | No. 6 | | | | | |
| Comparative | (A) | Chloroform | 98 | 10 | 3200 | 5.0 |
| Example 1 | | | | | | |

Comparison between the results shown in Tables 2 and 3 confirmed that the external quantum efficiency of the organic light emitting device significantly improved when the light emitting layer 4 was formed of a host and a guest. The result confirmed that efficient energy transfer from an oligofluorene compound as a host to Ir(C₈-piq)₃ as a guest occurred. In addition, the result showed that the oligofluorene compound represented by the general formula (I) was useful as a host for the light emitting layer 4.

In addition, comparison between the organic light emitting devices of Example 5 and Comparative Example 1 showed that the device of Example 5 was superior to that of Comparative Example 1 in light emitting efficiency and lifetime. The result showed that an organic light emitting device using the oligofluorene compound represented by the general formula (I) was superior in light emitting efficiency and durability to an organic light emitting device using an oligofluorene compound all alkyl groups of which were long-chain alkyl groups.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-058181, filed Mar. 8, 2007, which is hereby incorporated by reference herein in its entirety.

What is claimed is:

1. An organic light emitting device comprising:
an anode;
a cathode; and
a layer containing an organic compound, the layer being interposed between the anode and the cathode,
wherein the layer containing an organic compound contains at least one kind of an oligofluorene compound represented by the following general formula (I): 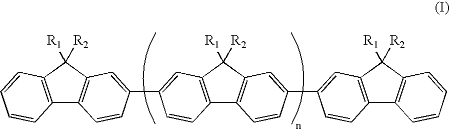
wherein:
R₁ and R₂ each represent an alkyl group, and may be identical to or different from each other, and R₁'s and R₂'s by which different fluorene rings are substituted may be identical to or different from each other, provided that at least four substituents of all substituents each represented by R₁ or R₂ each comprise an alkyl group having 4 or more carbon atoms, and at least four substituents of all the substituents each comprise an alkyl group having 1 or 2 carbon atoms; and
n represents an integer of 4 to 10.

2. The organic light emitting device according to claim 1, wherein the oligofluorene compound is non-liquid crystallinity.

3. The organic light emitting device according to claim 1, wherein the oligofluorene compound is contained in a light emitting layer.

4. The organic light emitting device according to claim 3, wherein:
the light emitting layer is formed of a host and a guest;
the host comprises the oligofluorene compound; and
the guest comprises a triplet light emitting material.

5. An ink composition comprising at least one kind of an oligofluorene compound represented by the following general formula (I).

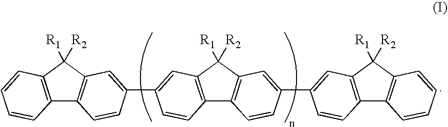

6. A display apparatus comprising the organic light emitting device according to claim 1.
